(19) United States
(12) Patent Application Publication
(10) Pub. No.: US 2006/0042817 A1
(43) Pub. Date: Mar. 2, 2006

(54) Submersible pump cable with air line

(76) Inventor: Paul Bello, Salem, OR (US)

Correspondence Address: MARGER JOHNSON & MCCOLLOM, P.C., 210 SW MORRISON STREET, SUITE 400, PORTLAND, OR, 97204, US

(21) Appl. No.: 10/925,665

(22) Filed: Aug. 24, 2004

(51) Int. Cl. H01B 7/00

(52) U.S. Cl. 174/113 R; 174/117 F

(57) ABSTRACT

According to embodiments of the invention, a submersible pump cable includes an air line for determining the depth at which a submersible pump lies beneath a liquid. Embodiments of the invention consequently provide increased durability to the air line and reduce the number of connections that are required to the submersible pump. Additional embodiments are described and claimed.

### BACKGROUND OF THE INVENTION

1. Technical Field of the Invention

This disclosure relates in general to submersible cables for pump applications, and more particularly, to improved submersible cables that incorporate an air line.

2. Description of the Related Art

Submersible pump cable is well-known in the art. As the name implies, submersible pump cable is used to supply current to submersible pumps. Submersible pump cable is used within the well casing, and a typical operating environment with temperatures between −40° and 75° C., in circuits not exceeding 600 V. One type of submersible pump cable, known as the twisted type, consists of four copper conductors, either solid or stranded, that are insulated with a PolyVinyl Chloride (PVC) sheath. The conductors and their PVC sheaths have a circular cross-section. One of the conductors is typically used as a ground connection. The four conductors, with their associated sheaths, are twisted around each other to form the submersible pump cable.

Another type of submersible pump cable used for heavy duty applications is the flat jacketed type. For this type of cable, each of the conductors and their PVC sheaths are laid out side-by-side, that is, parallel to each other. A flat PVC jacket is disposed around the outside of the circular PVC sheaths. The flat PVC jacket provides an additional measure of abrasion resistance.

Because the water table varies throughout the year, it is oftentimes desirable to know how much water is available to pump. For example, a submersible pump may be at the bottom of a well that is 300 feet deep. During a wet winter, the water table may be, for example, 50 feet below the ground surface. In other words, the pump is submerged under 250 feet of water. During a dry summer, however, the water table may drop, for example, by 50 feet. Consequently, the pump is now submerged under 200 feet of water.

Based upon the amount of water that is available, a pump may be adjusted to operate at a selected pumping rate. For example, one particular pump may be adjusted to pump between 5 gallons/minute to 100 gallons/minute. Other pumps may have different pumping rates. The fastest pumping rate might be used when the submerged depth of the pump is at a maximum and the slowest pumping rate might be used when the submerged depth of the pump is at a minimum.

A conventional way of determining how deep the pump is submerged below the surface of the water is by using an air line. The air line is nothing more than a hollow tube. One end of the air line is attached to the pump when it is submerged, but the end of the air line remains open to allow liquid and gas to pass through the end of the air line. The other end of the air line may be coupled to a pressure gauge and an air pump. The air pump is configured to occasionally pump air through the air line until all the liquid is expelled from the air line. The pressure gauge records the air pressure required to clear the liquid from the air line.

It is well known that 1 pound per square inch (p.s.i.) of pressure will raise a column of water by 2.31 feet. Conversely, a column of water 1 foot tall exerts a pressure of 0.434 p.s.i. Using these figures and the air pressure that was recorded by the pressure gauge, a calculation of the depth that the pump is submerged may be obtained. For example, if the pressure gauge records a pressure of 27.0 p.s.i., the pump lies submerged at a depth of 63.0 feet [(27.0 p.s.i.)×(2.31 feet/p.s.i.)=62.99 feet].

Currently, conventional air lines and conventional submersible pump cables are manufactured separately. Embodiments of the invention address this and other disadvantages of the conventional art.

### BRIEF DESCRIPTION OF THE DRAWINGS

FIG. 1 is a perspective diagram illustrating a flat jacket submersible pump cable that is combined with an air line according to some embodiments of the invention.

FIG. 2 is a perspective diagram illustrating a twisted submersible pump cable that is combined with an air line according to other embodiments of the invention.

### DETAILED DESCRIPTION OF THE INVENTION

Embodiments of the invention provide a combined submersible pump cable and air line. Consequently, the air line benefits from being protected by one or more of the conductors, PVC sheathing, and/or PVC jacket of the submersible pump cable. By incorporating the pump cable and air line into one combined cable, embodiments of the invention provide additional convenience and increased protection to the air line compared to the conventional art.

In the following detailed description, numerous exemplary embodiments of the invention will be described with reference to the attached FIGURES. Although the specification below may refer to “an”, “one”, “another”, or “some” embodiment(s) in several locations, this does not necessarily mean that each such reference is to the same embodiment(s), or that the feature described only applies to a single embodiment.

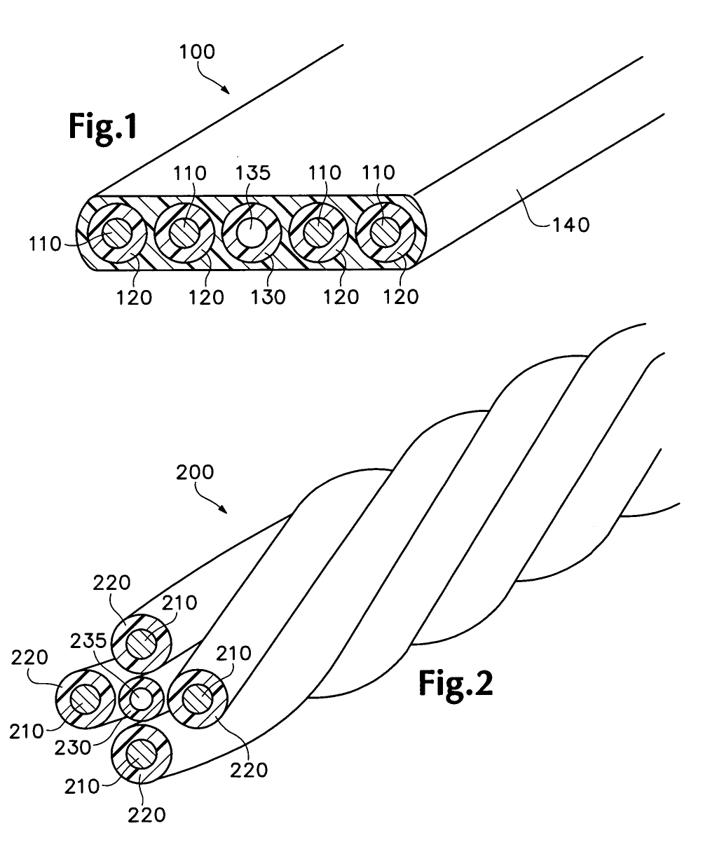

FIG. 1 is a perspective diagram illustrating a flat jacket submersible pump cable that is combined with an air line according to some embodiments of the invention.

The submersible pump cable 100 includes four conductors 110 and one air line 130. The conductors 110 may be composed of a single large copper wire or many small strands of copper wire twisted together. In alternative embodiments other metals may be used to form the conductors 110.

The conductors 110 are surrounded by PVC sheaths 120 that have ring-shaped cross sections. As shown in FIG. 1, the air line 130 may itself be a PVC sheath that has a ring-shaped cross section. The air line 130 defines a circular void 135 that runs the length of the air line 130. The circular void 135 and the air line 130 together form the hollow tube that is used to measure the height of the water above the submersible pump.

The submersible pump cable 100 also includes a flattened PVC jacket 140 that is disposed around the PVC sheaths 120 and the air line 130. The PVC jacket 140 holds the PVC sheaths 120 and the air line 130 in a side by side, parallel configuration.

Although in these embodiments the air line 130 is positioned centrally among the conductors 110, alternative embodiments may have the air line 130 in a different position relative to the conductors 110 and PVC sheaths 120.

Consequently, according to the embodiments described above, a submersible pump cable 100 of the flat jacket type may also include an air line 130 within the PVC jacket 140, thus providing additional durability to the air line 130. Additionally, since the air line 130 is now part of the submersible pump cable 100, the additional connection to the submersible pump required by the conventional air line is conveniently eliminated.

FIG. 2 is a perspective diagram illustrating a twisted submersible pump cable that is combined with an air line according to other embodiments of the invention.

A submersible pump cable 200 includes four conductors 210 and one air line 230. The conductors 210 may be composed of a single large copper wire or many small strands of copper wire twisted together. In alternative embodiments other metals may be used to form the conductors 210.

The conductors 210 are surrounded by PVC sheaths 220 that have ring-shaped cross sections. The air line 230 may itself be a PVC sheath that has a ring-shaped cross section. The air line 230 defines a circular void 235 that runs the length of the air line 230. The circular void 235 and the air line 230 together form the hollow tube that is used to measure the height of the water above the submersible pump.

In the embodiments illustrated in FIG. 2, the conductors 210 and their protective PVC sheaths 220 are twisted around the air line 230, thereby protecting it from abrasion. This is the preferred embodiment. However, in alternative embodiments the air line 230 may be in a different position relative to the conductors 210 and PVC sheaths 220. That is, instead of being centrally located among the twisted conductors 210 and PVC sheaths 220, the air line 230 may itself be twisted together with the conductors 210 and sheaths 220.

Consequently, according to the embodiments described above, a submersible pump cable 200 of the twisted type may also include an air line 230 centrally located among the twisted conductors 110, thus providing additional durability to the air line 230. Additionally, since the air line 230 is now part of the submersible pump cable 200, the additional connection to the submersible pump that is required by the conventional air line is conveniently eliminated.

Having described several exemplary embodiments of the invention, it should be apparent that modifications and variations of the described embodiments that do not depart from the inventive concepts disclosed above will be obvious to those of skill in the art.

For example, the flat jacket type of submersible pump cable and the twisted type of submersible pump cable described above are just two examples of submersible pump cables. Other embodiments of the invention may include an air line together with another type of submersible pump cable.

As yet another example, embodiments of the invention may also include more than one air line in the submersible pump cable. This would provide a backup air line if one of them became damaged or clogged.

As another example, in the embodiments described above with respect to FIG. 1 the protective PVC sheaths for the conductors had approximately the same diameter as the air line. In alternative embodiments, such as the embodiments described in FIG. 2, the diameter of the PVC sheaths may be smaller or larger than the diameter of the air line.

As another example, the embodiments described above were assumed to be used in water pumping application. However, the embodiments described above may work equally well in applications where a liquid other than water is being pumped.

Finally, it should be apparent that even though the embodiments described above used copper conductors and PVC for the insulating material, alternative embodiments may use conductors of different metals and insulating material of different types.

Consequently, the scope of the invention should not be limited only to the embodiments described above, but to all embodiments as defined and encompassed by the attached claims.

1. A cable comprising:
a conductive wire; and
an air line that is structured to be pressurized internally with an air pump that is coupled to the air line.

2. The cable of claim 1, further comprising an insulating sheath surrounding the conductive wire.

3. The cable of claim 2, wherein the conductive wire and insulating sheath are twisted around the air line.

4. The cable of claim 3, wherein the insulating sheath is composed of polyvinyl chloride and the conductive wire is composed of copper.

5. The cable of claim 2, further comprising a jacket surrounding the insulating sheath and the air line.

6. The cable of claim 5, wherein the jacket has a flattened cross section and holds the insulating sheath in contact with the air line.

7. The cable of claim 6, wherein the jacket and insulating sheath are composed of polyvinyl chloride and the conductive wire is composed of copper.

8. A submersible pump cable comprising:
a conductive wire; and
a hollow air line that defines a circular void that runs the length of the hollow air line, an end of the hollow air line structured to be coupled to an air pump and another end of the hollow air line structured to allow a liquid or a gas to enter and exit the circular void.

9. The submersible pump cable of claim 8, further comprising an insulating sheath surrounding the conductive wire.

10. The submersible pump cable of claim 9, wherein the conductive wire and insulating sheath are twisted around the hollow air line.

11. The submersible pump cable of claim 10, wherein the insulating sheath is composed of polyvinyl chloride and the conductive wire is composed of copper.

12. The submersible pump cable of claim 9, further comprising a jacket surrounding the insulating sheath and the hollow air line.

13. The submersible pump cable of claim 12, wherein the jacket has a flattened cross section and holds the insulating sheath in contact with the hollow air line.

14. The submersible pump cable of claim 13, wherein the jacket and insulating sheath are composed of polyvinyl chloride and the conductive wire is composed of copper.

15. A submersible cable comprising:
a conductive wire; and
an air line that is structured to be pressurized when submerged.

16. The submersible cable of claim 15, further comprising an insulating sheath surrounding the conductive wire.

17. The submersible cable of claim 16, wherein the conductive wire and insulating sheath are twisted around the air line.

18. The submersible pump cable of claim 17, wherein the insulating sheath is composed of polyvinyl chloride and the conductive wire is composed of copper.

19. The submersible pump cable of claim 16, further comprising a jacket surrounding the insulating sheath and the air line.

20. The submersible pump cable of claim 19, wherein the jacket has a flattened cross section and holds the insulating sheath adjacent to the air line.
